(19) United States
(12) Patent Application Publication
(10) Pub. No.: US 2009/0037989 A1
(43) Pub. Date: Feb. 5, 2009

(54) METHOD FOR PRESENTING PASSWORD CODES IN MOBILE DEVICES FOR AUTHENTICATING A USER AT A PROTECTED INSTITUTION

(75) Inventors: Wilson Vicente Ruggiero, Sao Paulo - SP (BR); Ricardo Komatsu De Almeida, Sao Paulo - SP (BR); Leon Achjian, JR., Sao Paulo - SP (BR); Armin Werner Mittelsdorf, Sao Paulo - SP (BR)

Correspondence Address: DARBY & DARBY P.C., P.O. BOX 770, Church Street Station, New York, NY, 10008-0770, US

(73) Assignee: Scopus Tecnologia Ltda., Sao Paulo - SP (BR)

(21) Appl. No.: 11/953,399

(22) Filed: Dec. 10, 2007

(30) Foreign Application Priority Data
Aug. 3, 2007 (BR) PI0703261-7

(51) Int. Cl. H04L 9/32

(52) U.S. Cl. 726/6

(57) ABSTRACT

The method of the invention allows presenting, in a friendly and intuitive form, to a user of a protected institution, access password codes arranged in the form of a table and to be individually and only once utilized for authenticating a user upon a respective operation to access said institution. The method proposed herein is particularly adequate for the representation of passwords in a mobile device, such as cell phone, PDA, and the like, utilizing a representation practically identical to the tables of printed passwords and already utilized by many users. There are additional advantages in relation to the use of printed tables, such as the possibility of highlighting a determined password, searching a determined index, protecting the tabular token application by password, and updating the passwords, and the like.

### FIELD OF THE INVENTION

The present invention refers to a method to friendly and intuitively present, to a user of a protected institution, access password codes to be individually and only once utilized for his authentication upon a respective access operation to said institution. The method proposed herein is particularly adequate for the representation of passwords in a mobile device, such as cell phone, PDA and the like. The form utilized is highly familiar, the authentication passwords being defined by a list or table of alphabetic, numerical or alphanumerical characters, generally disposed in matrix arrangement or otherwise indexed to be associated with respective characters or indices in the form of challenges supplied by the institution, in accordance with said password code.

### PRIOR ART

The proliferation of trojan horses, viruses, spying equipment installed in automatic teller machines (ATM), etc., which are utilized by fraudsters to intercept passwords to access protected institutions, such as the banking institutions, has created the need for new methods to guarantee a correct and secure identification (authentication) of the users of the institution.

In one end of the range of solutions, there are found the physical tokens and the biometric systems that have a high cost to be adopted in a large scale. In the other end, there are low cost solutions, such as new ways of inputting password, such as: virtual keyboards for typing through mouse, mixing of access letters in the terminal key, etc., which, in spite of being safer, are still susceptible to more elaborated forms of interception.

A solution for the problem of interception is to turn it innocuous. Therefore, each password must be utilized only once (OTP-one time password). There are several electronic devices available in the market which generate passwords, either from a challenge (variable character chain supplied by the institution interested in the user authentication), or from a time base, (in which case the challenge is the date and the hour). A solution being used for many years and which is world-widely utilized by several financial institutions is to supply a table (code) with pre-calculated (or even random) passwords for each user of this institution. This table or password code made of plastic or cardboard contains the passwords organized in cells, generally in a matrix arrangement, and indexed directly or through the positioning they occupy in said matrix arrangement.

The challenge utilized in electronic tokens corresponds, in the table or code, to the index of a cell or to its coordinates in the case of a matrix arrangement with the cells not individually indexed. The answer is the content of the requested cell(s) (password(s)). The client, who is the owner of the password code in the form of a table, answers the challenge, typing or saying the content of the cell(s) indexed by the challenge. Taking the correspondence of ideas to the extreme, in case a sufficiently large table (code) is provided, with the number of cells corresponding to the greatest numeric value of challenge accepted by an electronic device, the table or code could supply the same answers to the same challenges as this device and, therefore, said table or code would be indistinguishable therefrom under the point of view of the user's system. In view of practicability, however, the banks that make use of password systems of single use by a printed table (or code), limit the size of said table to about a hundred cells, each containing one or more characters.

In order that the password of the table or password code satisfies the OTP criteria—discard after use—the table (password code) must be periodically substituted, for example, at each one hundred authentications of the client. Due to problems regarding logistics and distribution of the tables, the banking institutions frequently reutilize the passwords of the table, not using the latter anymore in the OTP manner and, therefore, reducing the effectiveness of such systems against non authorized interception effected by third parts. The distribution cost, user convenience and fraud cost determine the procedure to be adopted. Besides the recurring cost for producing new tables (password codes), there is the cost for making them arrive safely to the client, through either sealed registered mail, or handed over in the premises of the institution, for example in the premises of a banking agency which, besides the operational costs involved, presents the inconvenience of requiring the client to visit his agency at each table (password code) substitution, wait in lines and be submitted to other discomforts.

The costs of distribution and renewal of the printed tables, besides incurring security risks, are making the electronic tokens be reconsidered, not in the form of physical tokens, but as programs or applications which run in mobile devices already pertaining to the user of the institution, such as cell phones or PDAs. This permits generating a very high number of OTPs and renewing them automatically.

An inconvenience is that substituting the printed table by a challenge-answer token can eliminate the familiarity of the user with a mechanism to which he is very used to.

### SUMMARY OF THE INVENTION

As a function of the inconveniences mentioned above, it is an object of the present invention to provide a method for presenting, to the user of a protected institution, such as a banking institution, password codes of authentication in a tabular form, in a very familiar way with the password table already utilized by said user.

According to the invention, the method comprises the steps of:

from a tabular token program of execution in the mobile device provided with a screen, determining the characteristics of the device screen;

mounting a password code in the form of a table on the screen of the mobile device, presenting as many positions and passwords as desired or possible, as a function of the screen size, in a manner that is similar to a printed table;

highlighting one of the table passwords to facilitate visualization thereof by the user;

reading the answer instructed by the user to the mobile device and adopting one of the following procedures:

changing the position of the table being presented in the mobile device screen;

changing the position of the password highlighted in the table;

modifying calculation parameters of the passwords;

activating other functionalities;

closing the program;

The present method further comprises, optionally, the step of making difficult the visualization of the passwords other than that highlighted in the mobile device screen, darkening or invalidating said passwords.

The invention summarizedly defined above solves the main problems related to the use of challenge-answer tokens, as it permits presenting a table or password code in the mobile device screen in a traditional printed form.

### BRIEF DESCRIPTION OF THE DRAWINGS

The invention will be described below, with reference to the enclosed drawings, given by way of example of an embodiment of the invention and in which:

FIG. 1 represents an exemplary password code in the form of a printed table; and

FIG. 2 represents a mobile device in the form of a cell phone, running the application which presents the password table on the screen thereof.

### DESCRIPTION OF THE INVENTION

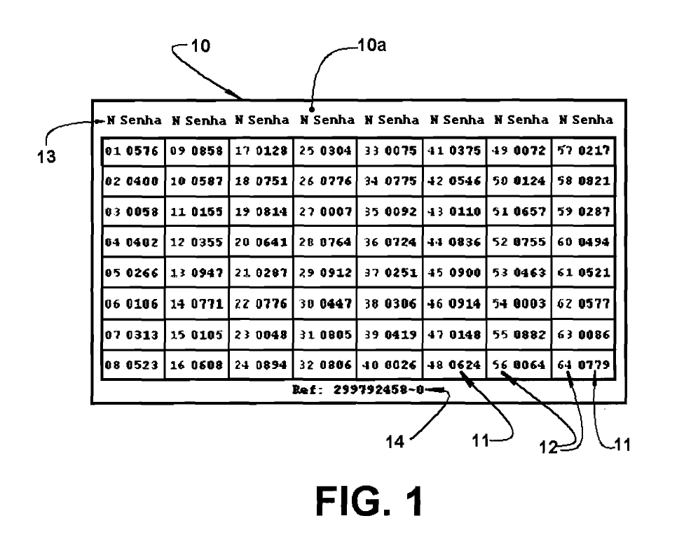

According to FIG. 1 of the enclosed drawings, the password code 10 takes the form of a printed table 10a containing a plurality of passwords 11, each one being defined by a set of characters grouped in a cell individually provided with an index 12 for its individual identification or indexation. The indices 12 related to each of the passwords 11 constitute the possible challenges which can be utilized by the institution for authenticating the user who is the owner of the password code 10 defined by said table 10a. It should be understood that said password code 10 can present different physical arrangements, with the passwords 11 defined by one or more numerical, alphabetical or alphanumerical characters, the indexation of each password 11 being carried out as a function of a certain matrix arrangement, similar to that of the printed tables. In this case, the challenge to be presented by the institution will be defined by indices which define the columns and the rows of said matrix arrangement of passwords 11. The table 10a can have additional information, such as a heading 13 indicating which characters compose the index and which characters compose the password. Other information, such as a reference number 14 or serial number, can be in the table 10a in any position.

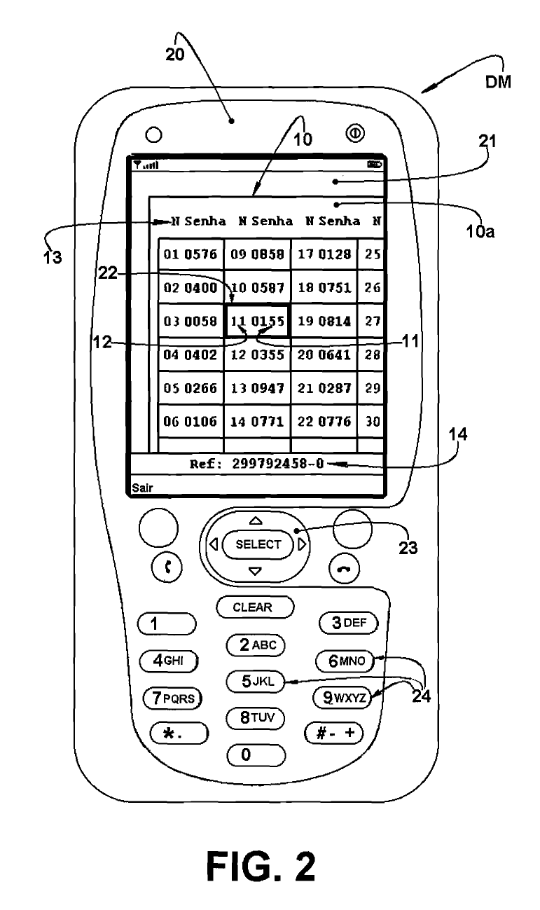

As can be noted in FIG. 2, part of the table 10a of passwords 11, as already mentioned in the description of FIG. 1, is presented in a mobile device DM represented as a cell phone 20. This device runs or processes a program, herein denominated tabular token, responsible for the drawing of the table 10a. Only part of the table 10a is visible due to limitations in the size of a screen 21 of the cell phone 20, which can range in size for different mobile devices DM. The present method includes the step of processing the events produced, by the user, in the data input means of his mobile device (DM), to change the visible part of the table (10a) being presented on the screen (21), to change the position of the index-password pair (22) highlighted in the table (10a) and to modify calculation parameters of passwords (11).

An index-password pair 22 is in the center of the screen 21 and highlighted from a differentiated edge. This highlighting has the function of calling the user's attention to the index-password pair 22 of a determined index 12. This highlighting can take other forms, such as characters of differentiated sizes, different colors, etc.

Cells composed by index-password pairs adjacent to the highlighted index-password pair 22 can have their content invalidated, blurred or darkened, to prevent the visualization of passwords 11 not necessary for the authentication in course. Thus, only an index-password pair 22 is visible each time. A higher security is provided against attackers which, by chance, can see or photograph the screen 21 of the mobile device DM, as they will see only the current index-password pair 22 but not the several adjacent ones which could be required in future authentications.

It is not only the central cell containing the central index-password pair 22 that can have a relevant value in an authentication. Other information of the printed table 10a, such as the reference number 14, might be necessary. Hence, parts of the screen 21 can be fixed, presenting important information, regardless of which part of the table 10a is being presented on the screen 21 of the mobile device DM represented by the cell phone 20.

Different parts of the table 10a can be visualized by interacting with the device, usually through its keyboard, running, or pointing systems, such as mouse and pens. The browsing arrows 23 are interesting for moving the table 10a in two directions (upwards, downwards, rightwards and leftwards). The numerical keyboard 24 can be used to go directly to a determined index 12, without the user having to make use of the browsing keys. Only two strokes are needed to browse in a table 10a with up to 100 positions, which are indexed with numbers from 00 to 99. It is important to note that the selection of the index-password pair 22 in highlighting can use one or more of the presented methods, according to the limitations of each device. The table 10a can be drawn on the screen of the mobile device DM in several ways. It can be a pre-stored image with all or part of the elements of the printed table 10a, or it can be an image containing a combination of background, indices 12, passwords 11, headings 13 or reference number 14 on the footline. All or part of the table can be drawn by the mobile device DM from geometric primitives.

An interesting aspect of the invention is that the passwords 11 of the table 10a presented in the mobile device DM can have their content originated from several ways, such as:

passwords pre-stored in the application in one of the forms of image, open data and cryptographed data;

passwords originated by the transfer of the passwords generated in the institution, instants after the installation of the application;

passwords generated from algorithms, such as:
tokens by events;
challenge-answer tokens;
pseudo-random numbers with known seed;
generation of especial sequences;
temporal tokens;
combination of these algorithms;

The updating or substitution of the tables 10a through the mechanisms cited above is very important to provide security for the authentication, preventing an attacker from collecting old passwords or passwords being captured while the user browses (displaces) the table on the screen of the mobile device DM.

An interesting configuration is to renew the passwords 11 automatically, according to a timetable known by the mobile device DM and by the institution, forming a mix of temporal token and challenge-answer.

The tabular token application can have additional protections and characteristics which are not possible for the table printed in physical card, such as:

finalization of the application after a determined usage time, inactivity or also as a function of an event;

the beginning of the application can be protected by a password, so that only the user can activate it;

application data and passwords can be automatically destroyed in case of violation attempt;

the table (10a), with the passwords (11), can be automatically or manually updated, without incurring costs of generation and sending of the printed table;

it can have a voice generation mechanism associated thereto, indicating the index 12 and/or the password 11 of the selected index-password pair 22, to help (to warn) visually handicapped users to identify said index-password pair.

1. A method for presenting password codes in mobile devices for authenticating a user at a protected institution such as, for example, a banking institution, comprising the steps of:
from a tabular token program of execution in the mobile device provided with a screen, determining the characteristics of the screen of the device;
mounting a password code in the form of a table on the screen of the mobile device, presenting as many positions and passwords as desired or possible, as a function of the screen size;
highlighting one of the passwords of the table to facilitate the visualization thereof by the user;
reading the answer instructed by the user to the mobile device and adopting one of the following procedures:
changing the position of the table being presented on the screen of the mobile device;
changing the position of the password highlighted in the table;
modifying calculation parameters of the passwords;
activating other functionalities;
closing the program.

2. The method, as set forth in claim 1, it further comprises the optional step of turning difficult the visualization of the passwords, except that password, highlighted on the screen of the mobile device.

3. The method, as set forth in claim 2, wherein said passwords, not highlighted on the screen, are darkened, invalidated or blurred.

4. The method, as set forth in claim 1, wherein the passwords contained in the table presented in the mobile device are originated from passwords pre-stored in one of the forms of image, open data and cryptographed data.

5. The method, as set forth in claim 1, wherein the passwords contained in the table presented in the mobile device are originated by the transfer of the passwords generated in the institution, instants after the installation of the application;

6. The method, as set forth in claim 1, wherein the passwords contained in the table presented in the mobile device are generated from any one of the algorithms defined by: tokens by events; challenge-answer tokens; pseudo-random numbers with known seed; special sequences; temporal tokens; and combination of these algorithms.

7. The method, as set forth in claim 1, wherein it comprises the step of finalizing the tabular token application after a determined time in any one of the conditions of use, inactivity and as a function of an event.

8. The method, as set forth in claim 1, wherein it has the beginning of the token application protected by a password.

9. The method, as set forth in claim 1, wherein the tabular token application and the passwords are automatically destroyed by the institution, in case of an attempt to violate the application.

10. The method, as set forth in claim 1, wherein the table with the passwords is updated either automatically or manually.

11. The method, as set forth in claim 1, wherein the browsing by the passwords of the table is operatively associated with a voice generation means, which warns visually handicapped users about at least one of the elements of index and password of the selected index-password pair.

12. The method, as set forth in claim 1, wherein the table, represented in the mobile device, presents the usual matrix form of the printed tables.

13. The method, as set forth in claim 1, wherein it comprises the step of processing the events produced, by the user, in the data input means of his mobile device, to change the visible part of the table being presented on the screen.

14. The method, as set forth in claim 1, wherein it comprises the step of processing the events produced, by the user, in the data input means of his mobile device, to change the position of the index-password pair highlighted in the table.

15. The method, as set forth in claim 1, wherein it comprises the step of processing the events produced, by the user, in the data input means of his mobile device, to modify calculation parameters of the passwords.

16. The method, as set forth in claim 1, wherein the tabular token application is protected by a password.

17. The method, as set forth in claim 1, wherein the tabular token application is updated by the institution.

18. The method, as set forth in claim 1, wherein the mobile device is defined by a cell phone.
